(19) United States
(12) Patent Application Publication
(10) Pub. No.: US 2025/0260316 A1
(43) Pub. Date: Aug. 14, 2025

(54) MULTI-PHASE SWITCHED-CAPACITOR OVERLAPPING GATE DRIVE

(71) Applicant: TEXAS INSTRUMENTS INCORPORATED, Dallas, TX (US)

(72) Inventors: Douglas Bouler, Knoxville, TN (US); Ryan Lind, Knoxville, TN (US); Eric Southard, Richardson, TX (US)

(21) Appl. No.: 18/812,025

(22) Filed: Aug. 22, 2024

Related U.S. Application Data
(60) Provisional application No. 63/551,242, filed on Feb. 8, 2024.

(51) Int. Cl. H02M 3/07; H02M 1/088

(52) U.S. Cl. CPC H02M 3/07; H02M 1/088

(57) ABSTRACT

A power converter includes a switch circuit having an input voltage terminal, an output voltage terminal, and a plurality of control inputs. The switch circuit includes a plurality of transistors. First and second capacitors have terminals coupled to the switch circuit. A control signal generator is coupled to the plurality of control inputs and is configured to sequence the plurality of transistors through first, second, third, fourth, fifth, and sixth control phases. In the first control phase, the first capacitor charges and the second capacitor discharges. In the second control phase, the first and second capacitors partially charge. In the third control phase, the second capacitor charges. In the fourth control phase, the first capacitor discharges and the second capacitor charges. In the fifth control phase, the first and second capacitors partially charge. In the sixth control phase, the first capacitor charges.

### CROSS-REFERENCE TO RELATED APPLICATIONS

This application claims priority to U.S. Provisional Application No. 63/551,242, filed Feb. 8, 2024, which is hereby incorporated by reference.

### BACKGROUND

A switched capacitor power converter converts an input voltage into an output voltage. The output voltage may be smaller than the input voltage. A switched capacitor power converter operates based on the principle of charging and discharging capacitors in a controlled manner to produce the output voltage.

### SUMMARY

In one example, a power converter includes a switch circuit having an input voltage terminal, an output voltage terminal, and a plurality of control inputs. The switch circuit includes a plurality of transistors. A first capacitor has first and second terminals coupled to the switch circuit. A second capacitor has a first and second terminals also coupled to the switch circuit. A control signal generator is coupled to the plurality of control inputs and is configured to sequence the plurality of transistors through first, second, third, fourth, fifth, and sixth control phases. In the first control phase, the first capacitor at least partially charges and the second capacitor at least partially discharges. In the second control phase, the first and second capacitors at least partially charge. In the third control phase, the second capacitor at least partially charges. In the fourth control phase, the first capacitor at least partially discharges and the second capacitor at least partially charges. In the fifth control phase, the first and second capacitors at least partially charge. In the sixth control phase, the first capacitor at least partially charges.

### BRIEF DESCRIPTION OF THE DRAWINGS

FIG. 1 is a system diagram of a switched capacitor power converter, in an example.

FIG. 2 is a schematic diagram of a 2:1 switched capacitor power converter, in an example.

FIG. 3 is a timing diagram illustrating the operation of the switched capacitor power converter of FIG. 2, in an example.

FIG. 4 is a schematic diagram of a 2:1 switched capacitor power converter, in another example.

FIG. 5 is a timing diagram illustrating the operation of the switched capacitor power converter of FIG. 4, in an example.

FIGS. 6A-6E illustrate the configuration of the switched capacitor power converter of FIG. 5 in different control phases, in an example.

FIG. 7 is a schematic diagram of a control signal generator for use in the switched capacitor power converter of FIG. 4, in an example.

FIG. 8 are waveforms illustrating the technical benefit of the switched capacitor power converter of FIG. 4.

FIG. 9 is a schematic diagram of a 3:1 switched capacitor power converter, in another example.

FIG. 10 is a schematic diagram of a 4:1 switched capacitor power converter, in another example.

### DETAILED DESCRIPTION

The same reference numbers or other reference designators are used in the drawings to designate the same or similar (either by function and/or structure) features.

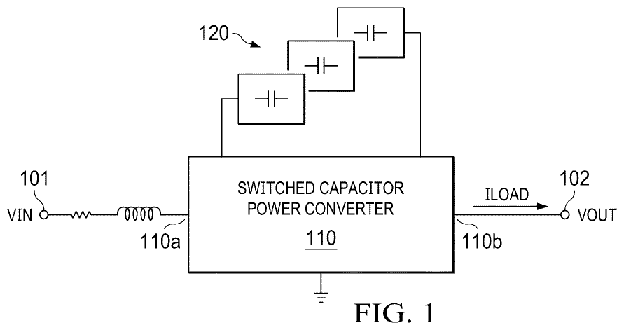

FIG. 1 is a system diagram of a switched capacitor power converter 110, in an example. Switched capacitor power converter 110 includes or is coupled to one or more capacitors 120 which may include an output capacitor and one or more flying capacitors. A flying capacitor is a capacitor that is charged when a circuit is in one configuration and then discharges when the circuit is in another configuration. Switched capacitor power converter 110 has an input voltage terminal 101 and output voltage terminal 102. An input voltage VIN is provided to the input voltage terminal 101, and the switched capacitor power converter 110 produces an output voltage VOUT at the output voltage terminal 102. Switched capacitor power converter 110 supplies a load current ILOAD to a load powered by the switched capacitor power converter.

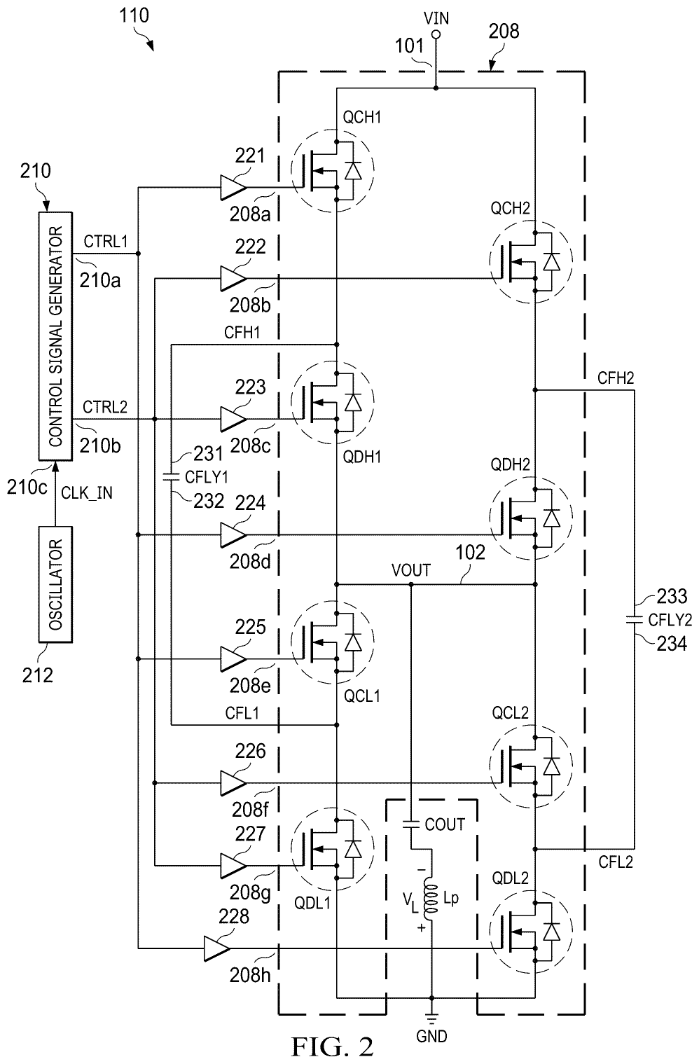

FIG. 2 is a schematic diagram of an example switched capacitor power converter 110. Switched capacitor power converter 110 is a 2:1 switched capacitor power converter in that input voltage VIN is twice the output voltage VOUT. The switched capacitor power converter of FIG. 2 includes a control signal generator 210, an oscillator 212, a switch circuit 208, drivers 221, 221, 223, 224, 225, 226, 227, and 228, and capacitors CFLY1, CFLY2, and COUT. Capacitors CFLY1 and CFLY2 are the flying capacitors noted above. Switch circuit 208 includes transistors QCH1, QCH2, QDH1, QDH2, QCL1, QCL2, QDL1, and QDL2. In this example, transistors QCH1, QCH2, QDH1, QDH2, QCL1, QCL2, QDL1, and QDL2 are n-channel field effect transistors (NFETs) but can be implemented as other types of transistors in other examples. Switch circuit includes an input voltage terminal 101, an output voltage terminal 102, and control inputs 208a, 208b, 208c, 208d, 208e, 208f, 208g, and 208h. Each of the control inputs (e.g., gates) of transistors QCH1, QCH2, QDH1, QDH2, QCL1, QCL2, QDL1, and QDL2 is coupled to a respective control input of the switch circuit's control inputs 208a-208h. For example, control input 208a is coupled to the gate of transistor QCH1. Control input 208b is coupled to the gate of transistor QCH2. Control input 208c is coupled to the gate of transistor QDH1. Control input 208d is coupled to the gate of transistor QDH2. Control input 208e is coupled to the gate of transistor QCL1. Control input 208f is coupled to the gate of transistor QCL2. Control input 208g is coupled to the gate of transistor QDL1. Control input 208h is coupled to the gate of transistor QDL2.

The drains of transistors QCH1 and QCH2 are coupled to the input voltage terminal 101. Transistors QCH1, QDH1, QCL1, and QDL1 are coupled in series between the input voltage terminal 101 and ground with the source of transistor QCH1 coupled to the drain of transistor QDH1, the source of QDH1 coupled to the drain of transistor QCL1, and the source of transistor QCL1 coupled to the drain of transistor QDL1. The source of transistor QDL1 is coupled to ground. The source of transistor QDH1 and the drain of transistor QCL1 are coupled to the output voltage terminal 102. Similarly, transistors QCH2, QDH2, QCL2, and QDL2 are coupled in series between the input voltage terminal 101 and ground with the source of transistor QCH2 coupled to the drain of transistor QDH2, the source of QDH2 coupled to the drain of transistor QCL1, and the source of transistor QCL1 coupled to the drain of transistor QDL1. The source of transistor QDL1 is coupled to ground. The source of transistor QDH1 and the drain of transistor QCL1 are coupled to the output voltage terminal 102.

Capacitor CFLY1 has terminals 231 and 232. Terminal 231 is coupled to the source of transistor QCH1 and to the drain of transistor QDH1. Terminal 232 is coupled to the source of transistor QCL1 and to the drain of transistor QDL1. Capacitor CFLY2 has terminals 233 and 234. Terminal 233 is coupled to the source of transistor QCH2 and to the drain of transistor QDH2. Terminal 234 is coupled to the source of transistor QCL2 and to the drain of transistor QDL2. Capacitor COUT is coupled between the output voltage terminal 102 and ground.

Each driver 221-228 has an input and an output. The outputs of drivers 221-228 are coupled to the respective gates of transistors QCH1, QCH2, QDH1, QDH2, QCL1, QCL2, QDL1, and QDL2. Control signal generator 210 has two outputs 210a and 210b and an input 210c. Output 210a is coupled to the inputs of drivers 221, 224, 225, and 228 and provides a signal CTRL1 to drivers 221, 224, 225, and 228. Output 210b is coupled to the inputs of drivers 222, 223, 226, and 227 and provides a signal CTRL2 to drivers 222, 223, 226, and 227. Accordingly, output 210a is coupled to transistors QCH1, QDH2, QCL1, and QDL2, and output 210b is coupled to transistors QCH2, QDH1, QCL2, and QDL1. Oscillator 212 has an output that is coupled to input 210c of control signal generator 210. Oscillator 212 produces a clock signal CLK_IN which is provided to the input 210c of control signal generator 210.

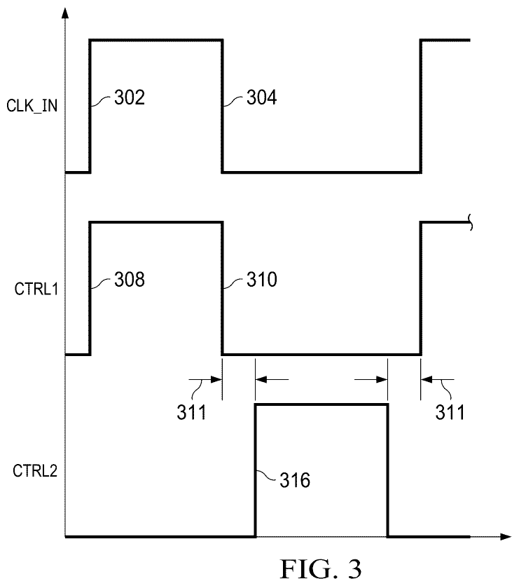

Control signal generator 210 generates signal CTRL1 and CTRL2 based on clock signal CLK_IN. FIG. 3 is an example timing diagram illustrating clock signal CLK_IN and signals CTRL1 and CTRL2. Responsive to a rising edge 302 of clock signal CLK_IN, control signal generator 210 asserts signal CTRL1 logic high as indicated by rising edge 308. Upon the next falling edge 304 of clock signal CLK_IN, control signal generator 210 forces signal CTRL1 to a logic low level as identified by falling edge 310 and, following a deadtime 311, signal CTRL2 to a logic high level as identified by rising edge 316. This process repeats with each rising edge of clock signal CLK_IN. In the example of FIG. 2, control signal generator 210 implements two control phases-one control phase in which signal CTRL1 is logic high and another control phase in which signal CTRL2 is logic high.

With signal CTRL1 at a logic high level (one control phase) and signal CTRL2 at a logic low level, transistors QCH1, QDH2, QCL1, and QDL2 are on and transistors QCH2, QDH1, QCL2, and QDL1 are off. In this state with transistors QCH1 and QCL1 on, capacitor CFLY1 charges with the voltage at terminal 232 of capacitor CFLY1 at the output voltage VOUT and terminal 231 of capacitor CFLY1 at the input voltage VIN. Further, with transistors QDH2 and QDL2 on, capacitor CFLY2 discharges at least some of its charge into the output terminal 102. With signal CTRL2 at a logic high level (the other control phase) and signal CTRL1 at a logic low level, transistors QCH1, QDH2, QCL1, and QDL2 are off and transistors QCH2, QDH1, QCL2, and QDL1 are on. In this state with transistors QCH2 and QCL2 on, capacitor CFLY2 charges with the voltage at terminal 234 of capacitor CFLY2 at the output voltage VOUT and terminal 233 of capacitor CFLY2 at the input voltage VIN. Further, with transistors QDH1 and QDL1 on, capacitor CFLY1 discharges at least some of its charge into the output terminal 102.

Accordingly, as the control phases reciprocate back and forth in synchronization with the clock signal CLK_IN, one of the capacitors CFLY1 and CFLY2 charges while the other of capacitors CFLY1 and CFLY2 discharges, and then the role of the capacitors reverses such that the capacitor that previously discharged now charges and the capacitor that previously charged now discharges, and so on. During each of the control phases, the load current ILOAD is supplied through capacitors CFLY1 and CFLY2. During the deadtime 311, control signal generator 210 turns off all of transistors QCH1, QCH2, QDH1, QDH2, QCL1, QCL2, QDL1, and QDL2. The deadtime 311 ensures that the input voltage terminal 101 does not short to the output voltage terminal 102, that the output voltage terminal 102 does not short to ground, and that the input voltage terminal 101 does not short to ground. During the two control phases, capacitor COUT is charged to the output voltage COUT. During the deadtime 311, the load current ILOAD is supplied by capacitor COUT.

FIG. 2 also shows at least one parasitic inductance Lp between capacitor COUT and ground. Parasitic inductance Lp represents the combination of the parasitic inductance of the conductor coupling capacitor COUT to ground and the parasitic inductance of capacitor COUT. Capacitor COUT at least partially discharging during deadtime 311 results in several problems. First, during the control phases, capacitor COUT does not provide much or any current to the load but during the deadtimes 311, the rate of change in current through capacitor COUT generates a voltage V_{L} across the parasitic inductance Lp. The voltage V_{L} may force the output voltage VOUT low enough (e.g., negative) such that the body diodes of transistors QDL1, QCL1, QDL2, and QCL2 (the transistors between ground and the output voltage terminal 102) may be forward biased and thus conduct current, which results in power loss in the body diodes. Second, at the end of the deadtime 311, current to load is sourced through the transistors as described above rather than from capacitor COUT. Accordingly, the rate of change of current through capacitor COUT may be a large negative value (current rapidly decreasing) which causes voltage V_{L} to be a negative voltage and thereby causes a large overshoot for the output voltage VOUT. These problems are caused because capacitor COUT is forced to source current to the load during the deadtimes 311 of switched capacitor power converter 110. As charge is supplied by capacitor COUT during the deadtimes 311, the capacitors CFLY1 and CFLY2 replenish the charge in capacitor COUT. Such “charge-sharing” between capacitors CFLY/CLFY2 and COUT results in relatively high peak currents through the discharging current path (e.g., a discharging current path through transistor QDH1, capacitor CFLY1, and transistor QDL1 and another discharging current path through transistor QDH2, capacitor CFLY2, and transistor QDL2) and manifests as conduction losses.

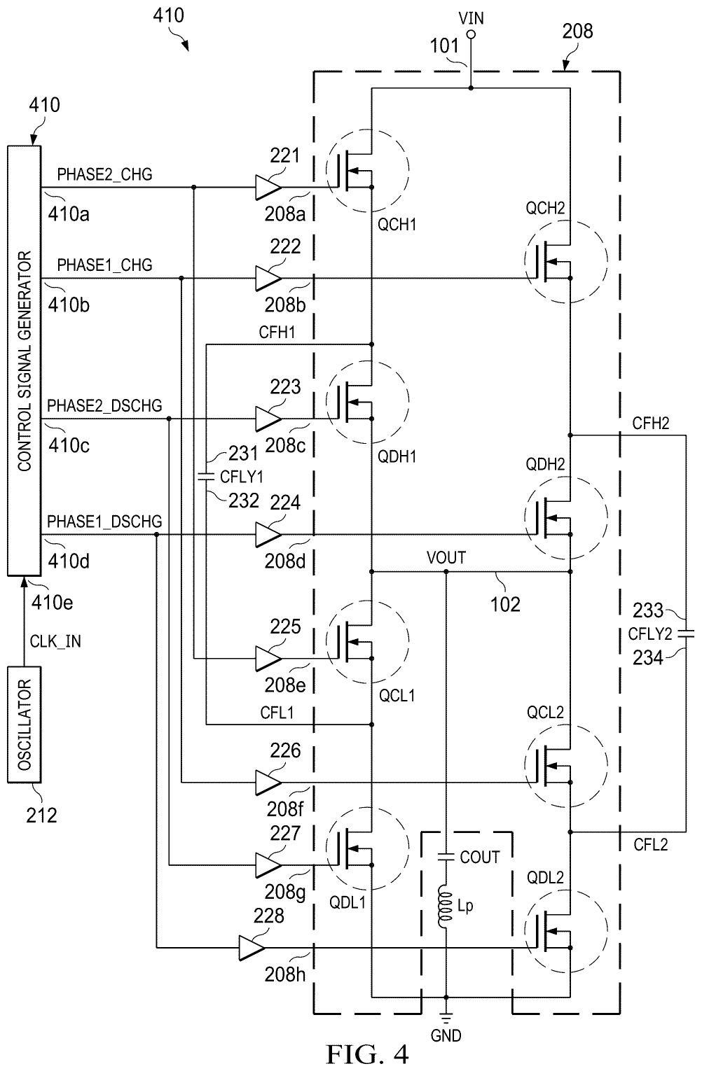

FIG. 4 is a schematic diagram of a 2:1 switched capacitor power converter 410 that addresses the problems described above with respect to switched capacitor power converter 110 of FIG. 2. Switched capacitor power converter 410 includes oscillator 212, a control signal generator 410, the switch circuit 208, capacitor CFLY1, CFLY2, COUT, and drivers 221-228. Switch circuit 208 is constructed largely the same as described above regarding FIG. 2. The coupling of capacitors CFLY1, CFLY2, and COUT to the switch network 208 and output voltage terminal 102 also is largely the same as described above.

Control signal generator 410 includes an input 410e and outputs 410a, 410b, 410c, and 410d. Whereas control signal generator 210 in the example of FIG. 2 has two outputs 210a and 210b, control signal generator 410 in the example of FIG. 4 has four outputs 410a-410d. Output 410a is coupled to inputs of drivers 221 and 225. Output 410b is coupled to inputs of drivers 222 and 226. Output 410c is coupled to inputs of drivers 223 and 227. Output 410d is coupled to inputs of drivers 224 and 228. Accordingly, via the respective drivers 221-228, each output 410a-410d is coupled to two of the inputs 208a-208h of switch circuit 208. Control signal generator 410 generates a control signal PHASE2_CHG at its output 410a, a control signal PHASE1_CHG at its output 410b, a control signal PHASE2_DSCHG at its output 410c, and a control signal PHASE1_DSCHG at its output 410d. This configuration of the outputs 410a-410d of control signal generator 410 to the inputs 208a-208h of switch circuit 208 allows control signal generator 410 to sequence the on and off states of transistors QCH1, QCH2, QDH1, QDH2, QCL1, QCL2, QDL1, and QDL2 through multiple control phases without COUT having to source current to the load during a deadtime. In one example, the number of control phases is 6.

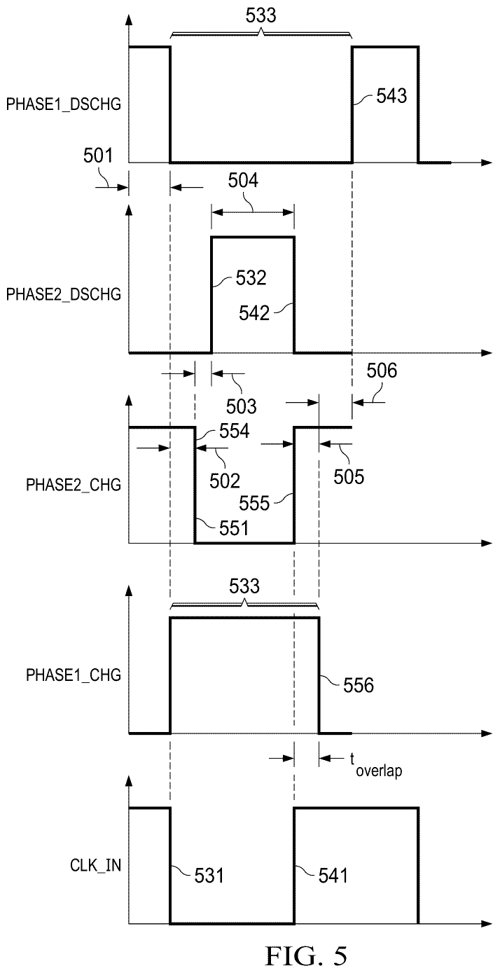

FIG. 5 is a timing diagram including example waveforms for control signals PHASE1_DSCHG, PHASE2_DSCHG, PHASE1_CHG, and PHASE2_CHG. The timing diagram of FIG. 5 also illustrates six control phases 501, 502, 503, 504, 505, and 506. Control signal generator 410 generates the control signals PHASE2_CHG, PHASE1_CHG, PHASE2_DSCHG, and PHASE1_DSCHG based on the clock signal CLK_IN. In this example, a logic high for any of the control signals PHASE2_CHG, PHASE1_CHG, PHASE2_DSCHG, and PHASE1_DSCHG causes the respective drivers 221-228 to turn on the corresponding transistor and a logic low causes the drivers to turn off the corresponding transistors.

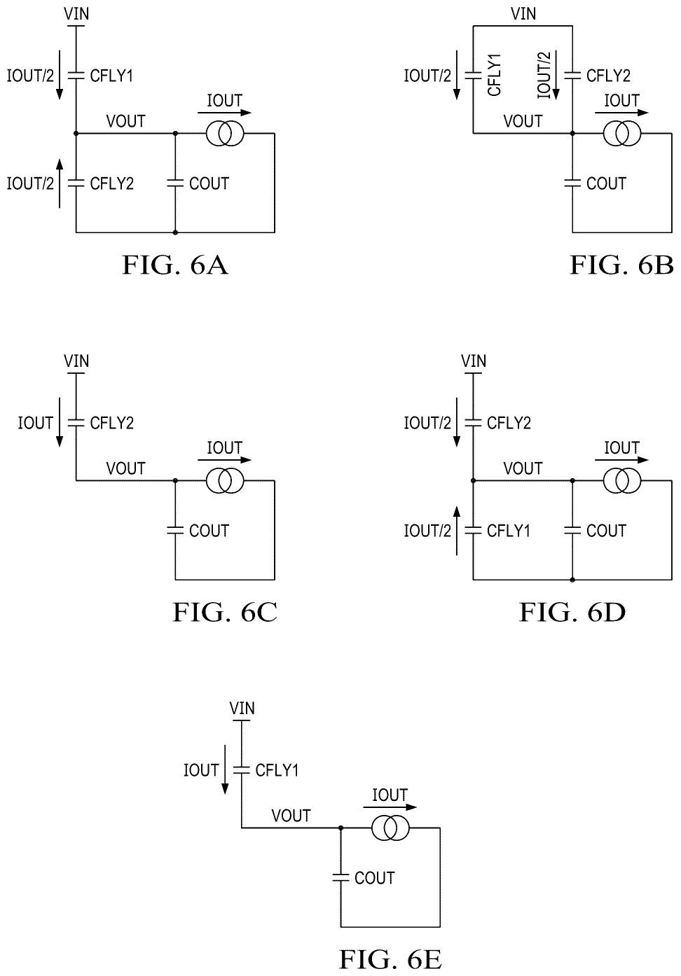

FIGS. 6A, 6B, 6C, 6D, and 6E schematically illustrate the configuration of the switch circuit 208 during the six control phases and are discussed below with the corresponding control phase. In control phase 501, control signal generator 410 asserts control signals PHASE1_DSCHG and PHASE2_CHG logic high and control signals PHASE2_DSCHG and PHASE1_CHG logic low. With the control signals at these logic states, transistors QCH1, QDH2, QCL1, and QDL2 are on and transistors QCH2, QDH1, QCL2, and QDL1 are off. As illustrated in FIG. 6A, with transistors QCH1, QDH2, QCL1, and QDL2 on and transistors QCH2, QDH1, QCL2, and QDL1 off, capacitor CFLY1 charges and also sources some of the output current IOUT to the output voltage terminal and capacitor CFLY2 (which was previously charged) at least partially discharges into the output voltage terminal 102.

In control phase 502, control signal generator 410 continues to assert control signal PHASE2_CHG logic high and also asserts control signal PHASE1_CHG logic high but forces control signal PHASE1_DSCHG logic low. With control signals PHASE1_CHG and PHASE2_CHG logic high and control signals PHASE1_DSCHG and PHASE2_DSCHG logic low, transistors QCH1, QCH2, QCL1, and QCL2 are on and transistors QDH1, QDH2, QDL1, and QDL2 are off. As illustrated in FIG. 6B, with the transistors in this state, capacitors CFLY1 and CFLY2 continue to charge and also source output current IOUT to the output voltage terminal 102. Approximately one-half the output current IOUT is provided through each of capacitors CLFY1 and CLFY2.

In control phase 503, control signal generator 410 forces control signal PHASE2_CHG logic low continues to assert control signal PHASE1_CHG logic high. With control signal PHASE1_CHG logic high and control signals PHASE1_DSCHG, PHASE2_DSCHG, and PHASE2_CHG logic low, transistors QCH2 and QCL2 are on and transistors QCH1, QDH1, QDH2, QCL1, QDL1, and QDL2 are off. As illustrated in FIG. 6C, with the transistors in this state, capacitor CFLY2 continues to charge and sources output current IOUT to the output voltage terminal 102.

In control phase 504, control signal generator 410 forces control signal PHASE2_DSCHG logic high and continues to assert control signal PHASE1_CHG logic high. With control signals PHASE2_DSCHG and PHASE1_CHG logic high and control signals PHASE1_DSCHG and PHASE2_CHG logic low, transistors QDH1, QDL1, QCH2, and QCL2 are on and transistors QCH1, QCL1, QDH2, and QDL2 are off. As illustrated in FIG. 6C, with the transistors in this state, capacitor CFLY1 discharges to the output voltage terminal 102 and capacitor CFLY2 charges while also sourcing current to the output voltage terminal 102. Approximately one-half of the output current IOUT flows from each of capacitors CFLY1 and CFLY2.

In control phase 505, control signal generator 410 forces control signal PHASE2_CHG logic high and continues to assert control signal PHASE1_CHG logic high. With control signals PHASE1_CHG and PHASE2_CHG logic high and control signals PHASE1_DSCHG and PHASE2_DSCHG logic low, transistors QCH1, QCL1, QCH2, and QCL2 are on and transistors QDH1, QDL2, QDH2, and QDL2 are off. As illustrated in FIG. 6B and described above regarding control phase 502, capacitors CFLY1 and CFLY2 charge and also source output current IOUT to the output voltage terminal 102. Approximately one-half the output current IOUT is provided through each of capacitors CLFY1 and CLFY2

In control phase 506, control signal generator 410 forces control signal PHASE2_CHG logic high and control signals PHASE1_CHG, PHASE1_DSCHG, and PHASE2_DSCHG logic low. With control signal PHASE1_CHG logic high and control signals PHASE1_CHG, PHASE1_DSCHG, and PHASE2_DSCHG logic low, transistors QCH1 and QCL1 are on and transistors QCH2, QDH1, QDH2, QCL2, QDL1, and QDL2 are off. As illustrated in FIG. 6E, with the transistors in this state, capacitor CFLY1 charges and also sources output current IOUT to the output voltage terminal 102.

The control phases 501-506 implement a control technique for transistors QCH1, QCH2, QDH1, QDH2, QCL1, QCL2, QDL1, and QDL2 such that capacitor COUT does not supply any, or at least not more than a negligible amount of, current to the output voltage terminal. Accordingly, the problems described above in which a significant voltage drop develops across the parasitic inductance Lp are avoided with the control technique described in FIGS. 4-6E.

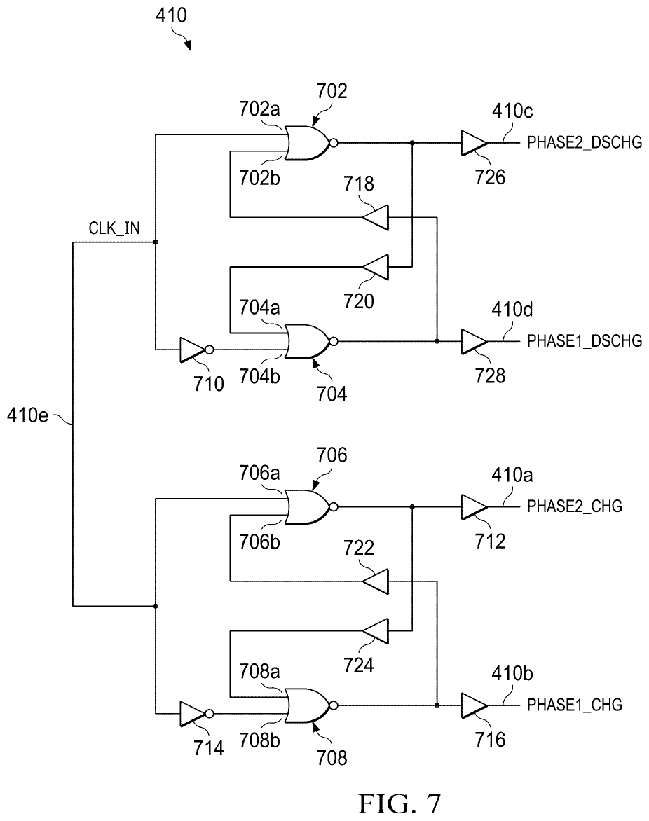

FIG. 7 is a schematic diagram of an example of control signal generator 410. In this example, control signal generator 410 includes NOR gates 702, 704, 706, and 708, inverters 710, 712, 714, and 716, delays 718, 720, 722, and 724, and buffers 726 and 728. NOR gate 702 has inputs 702a and 702b. NOR gate 704 has inputs 704a and 704b. NOR gate 706 has inputs 706a and 706b. NOR gate 708 has inputs 708a and 708b. Input 410e is coupled to inputs 702a and 706a of NOR gates 702 and 706, respectively, and to inputs of inverters 710 and 714. Accordingly, clock signal CLK_IN is provided to inputs 702a and 706a and to inputs of inverters 710 and 714. The output of NOR gate 702 is coupled to an input of buffer 726, whose output is coupled to output 410c and provides control signal PHASE2_DSCHG. The output of NOR gate 702 also is coupled to an input of delay 720, whose output is coupled to input 704a of NOR gate 704. The output of inverter 710 is coupled to input 704b of NOR gate 704. The output of NOR gate 704 is coupled to an input of buffer 728, which is coupled to output 410d and provides control signal PHASE1_DSCHG, and to an input of delay 718. The output of delay 718 is coupled to input 702b of NOR gate 702.

The output of NOR gate 706 is coupled to an input of inverter 712, whose output is coupled to output 410a and provides control signal PHASE2_CHG. The output of NOR gate 702 also is coupled to an input of delay 724, whose output is coupled to input 708a of NOR gate 708. The output of inverter 714 is coupled to input 708b of NOR gate 708. The output of NOR gate 708 is coupled to an input of inverter 716, which is coupled to output 410b and provides control signal PHASE1_CHG, and to an input of delay 722. The output of delay 722 is coupled to input 706b of NOR gate 706.

The time delays implemented by delays 718, 720, 722, and 724 may all be the same or different. Delay 718 implements the time period between the falling edge 531 (FIG. 5) of clock signal CLK_IN and the rising edge 532 of control signal PHASE2_DSCHG. Upon occurrence of falling edge 531, clock signal CLK_IN will be a logic 0 and the output of inverter 710 will be logic 1. With input 704b of NOR gate 704 at a logic 1, the output of NOR gate 704 will be logic 0 and, accordingly, control signal PHASE1_DSCHG will be logic 0 as shown at 533 in FIG. 5. Following the time period implemented by delay 718, input 702b of NOR gate 702 becomes a logic 0. With both inputs 702a and 702b at logic 0, the output of NOR gate 702 becomes a logic 1 and, accordingly, control signal PHASE2_DSCHG transitions to logic 1 at rising edge 532.

Upon the subsequent rising edge 541 of clock signal CLK_IN, input 702a of NOR gate 702 is at a logic 1 and, accordingly, the output of NOR gate 702 becomes a logic 0 thereby forcing control signal PHASE2_DSCHG to a logic 0 at falling edge 542. Following the time period implemented by delay 720, input 704a of NOR gate 704 also becomes a logic 0. With both inputs of 704a and 704b of NOR gate 704 at logic 0, the output of NOR gate 704 is a logic 1 thereby causing control signal PHASE1_DSCHG to logic 1 at rising edge 543. Accordingly, delay 720 implements the time period between the rising edge 541 of clock signal CLK_IN and the rising edge 543 of control signal PHASE1_DSCHG.

Referring again to the falling edge 531 of clock signal CLK_IN, the input 706a of NOR gate 706 and the input of inverter 714 will be a logic 0. The output of inverter 714 will be a logic 1. With input 708b of NOR gate 708 at a logic 1, the output of NOR gate 708 will be logic 0 and the output of inverter 716 will be a logic 1. Accordingly, control signal PHASE1_CHG will be logic 1 as shown at 553 in FIG. 5. Following the time period implemented by delay 722, input 706b of NOR gate 706 becomes a logic 0. With both inputs 706a and 706b at logic 0, the output of NOR gate 706 becomes a logic 1 and, accordingly, through inverter 712, control signal PHASE2_CHG transitions to logic 0 at falling edge 554.

Upon the subsequent rising edge 541 of clock signal CLK_IN, input 706a of NOR gate 706 is at a logic 1 and, accordingly, the output of NOR gate 706 becomes a logic 0 thereby, through inverter 712, forcing control signal PHASE2_CHG to a logic 1 at rising edge 555. Following the time period implemented by delay 724, input 708a of NOR gate 708 also becomes a logic 0. With both inputs of 708a and 708b of NOR gate 708 at logic 0, the output of NOR gate 708 is a logic 1 thereby causing, through inverter 716, control signal PHASE1_CHG to logic 1 at rising edge 556. Accordingly, delay 724 implements the time period between the rising edge 541 of clock signal CLK_IN and the falling edge 556 of control signal PHASE1_CHG.

The time periods implemented by delays 718, 720, 722, and 724 may all be the same or two more of the time periods may be different than each other. In one example, the time periods implemented by delays 718 and 720 are 45 ns and the time periods implemented by delays 722 and 724 are 35 ns. In some examples, the time periods implemented by delays 718, 720, 722, and 724 are 1-2% of the period of clock signal CLK_IN.

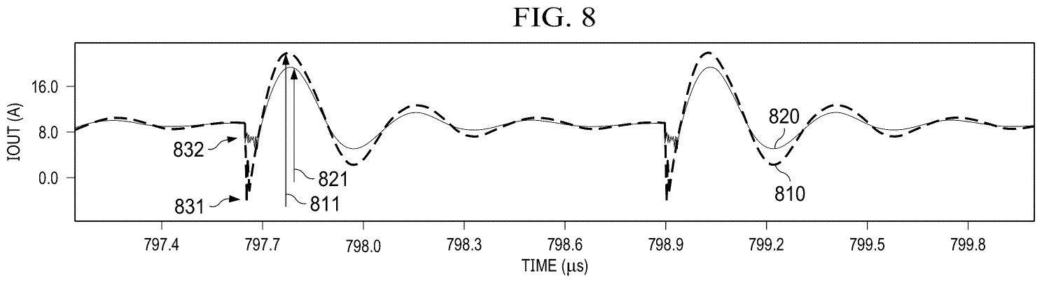

FIG. 8 includes example waveforms illustrating the technical benefit of the control technique of FIGS. 4-6E relative to the control technique of FIGS. 2 and 3. Waveform 810 represents the output current IOUT for switched capacitor power converter 110 using the control technique of FIGS. 2 and 3. Waveform 820 represents the output current IOUT for switched capacitor power converter 410 using the control technique of FIGS. 4-6E. Waveform 820 illustrates less overshoot 821 than the overshoot 811 for waveform 810. Additionally, FIG. 8 illustrates that the output current of waveform 810 drops to approximately OA (reference numeral 831) during the deadtime 311. Output current IOUT of waveform 810 is the output current of switched capacitor power converter 110 without the current contribution of capacitor COUT. However, for waveform 820, the output current IOUT of switched capacitor power converter 410 remains at approximately its steady state level of approximately 8 A.

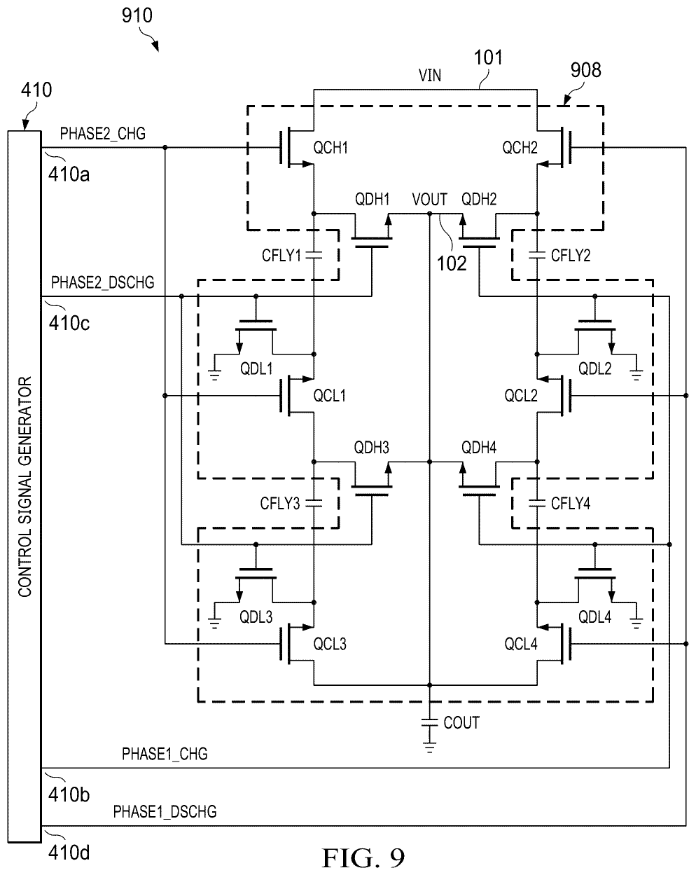

Switched capacitor power converters 110 and 410 in FIGS. 2 and 4, respectively, are 2:1 switched capacitor power converters. The control technique described above for switched capacitor power converter 410 can be extended to other types of switched capacitor power converters. For example, FIG. 9 is a schematic diagram of a 3:1 switched capacitor power converter 910 (input voltage VIN is three times the output voltage VOUT) which implements the same control technique as for switched capacitor power converter 410 of FIG. 4. Switched capacitor power converter 910 includes the control signal generator 410, a switch circuit 908, capacitors CFLY1, CFLY2, CFLY3, CFLY4, and COUT. For switched capacitor power converter 910, control signal generator 410 may be implemented the same (e.g. as in FIG. 7) as for switched capacitor power converter 410.

In addition to transistors QCH1, QCH2, QDH1, QDH2, QCL1, QCL2, QDL1, and QDL2, switch circuit 908 includes transistors QDH3, QDH4, QDL3, QDL4, QCL3, and QCL4. In this example, transistors QCH1, QCH2, QDH1, QDH2, QDL1, QDL2, QDH3, QDH4, QDL3, QDL4, QCL1, QCL2, QCL3 and QCL4 are NFETs. Capacitor CFLY1 is coupled between the sources of transistors QCH1 and QCL1. Capacitor CLY3 is coupled between the drain of transistor QCL1 and the source of transistor QCL3. Transistor CLY2 is coupled between the sources of transistors QCH2 and QCL2. Transistor CFLY4 is coupled between the drain of transistor QCL2 and the source of transistor QCL4. The drain of transistor QDL1 is coupled to capacitor CLFY1 and to the source of transistor QCL1. The source of transistor QDL1 is coupled to ground. The drain and source of transistor QDH1 are coupled to the source of transistor QCH1 and the output voltage terminal 102, respectively. The drain of transistor QDL2 is coupled to capacitor CLFY2 and to the source of transistor QCL2. The source of transistor QDL2 is coupled to ground. The drain and source of transistor QDH2 are coupled to the source of transistor QCH2 and the output voltage terminal 102, respectively.

The drain of transistor QDL3 is coupled to capacitor CLFY3 and to the source of transistor QCL3. The source of transistor QDL3 is coupled to ground. The drain and source of transistor QDH3 are coupled to the drain of transistor QCL1 and the output voltage terminal 102, respectively. The drain of transistor QDL4 is coupled to capacitor CLFY4 and to the source of transistor QCL4. The source of transistor QDL4 is coupled to ground. The drain and source of transistor QDH4 are coupled to the drain of transistor QCL2 and the output voltage terminal 102, respectively. The drains of transistors QCL3 and QCL4 are coupled together. Capacitor COUT is coupled between the output voltage terminal 102 and ground.

Output 410a of control signal generator 410 is coupled to, and provides control signal PHASE2_CHG to, the gates of transistors QCH1, QCL1, and QCL3. Output 410b of control signal generator 410 is coupled to, and provides control signal PHASE1_CHG to, the gates of transistors QCH2, QCL2, and QCL4. Output 410c of control signal generator 410 is coupled to, and provides control signal PHASE2_DSCHG to, the gates of transistors QDH1, QDL1, QDH3, and QDL3. Output 410d of control signal generator 410 is coupled to, and provides control signal PHASE1_DSCHG to, the gates of transistors QDH2, QDL2, QDH4, and QDL4.

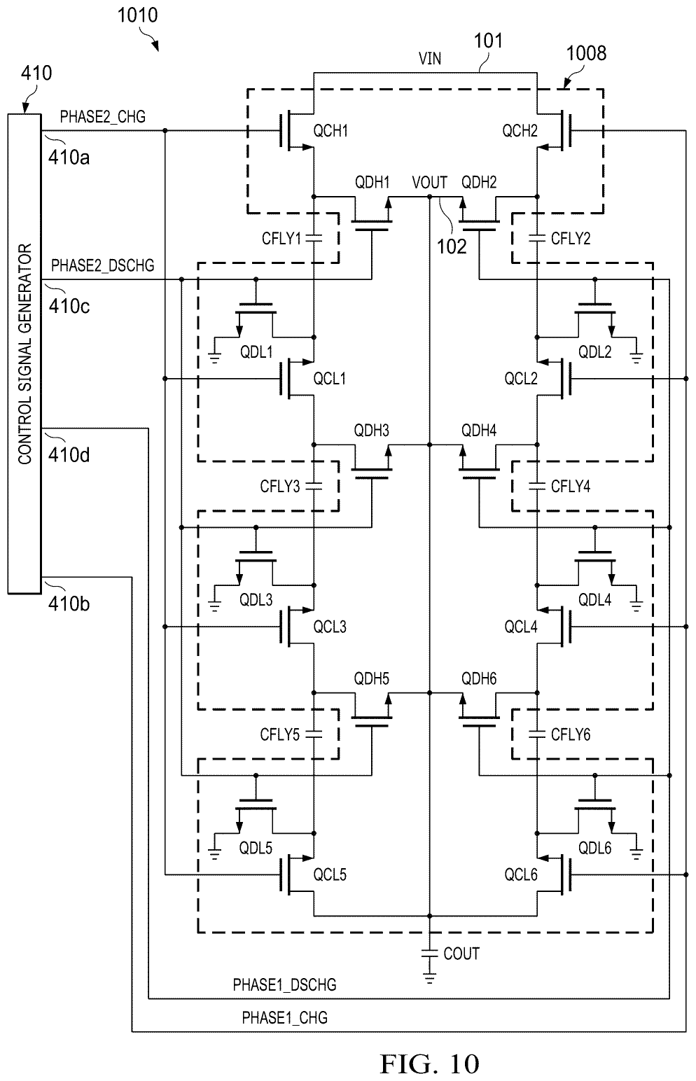

FIG. 10 is a schematic diagram of a 4:1 switched capacitor power converter 1010 (input voltage VIN is four times the output voltage VOUT) which implements the same control technique as for switched capacitor power converter 410 of FIG. 4. Switched capacitor power converter 1010 includes the control signal generator 410, a switch circuit 1008, capacitors CFLY1, CFLY2, CFLY3, CFLY4, CFLY5, CFLY6 and COUT. For switched capacitor power converter 910, control signal generator 410 may be implemented the same (e.g. as in FIG. 7) as for switched capacitor power converter 410.

In addition to transistors QCH1, QCH2, QDH1, QDH2, QCL1, QCL2, QDL1, QDL2, QDH3, QDH4, QDL3, QDL4, QCL3, and QCL4 for the 3:1 switched capacitor power converter 910 of FIG. 9, switch circuit 1008 in FIG. 10 includes transistors QDH5, QDH6, QDL5, QDL6, QCL5, and QCL6. In the example of FIG. 10, transistors QCH1, QCH2, QDH1, QDH2, QDL1, QDL2, QDH3, QDH4, QDL3, QDL4, QDH5, QDH6, QDL5, QDL6, QCL1, QCL2, QCL3 and QCL4 are NFETs. Capacitor CFLY1 is coupled between the sources of transistors QCH1 and QCL1. Capacitor CLY3 is coupled between the drain of transistor QCL1 and the source of transistor QCL3. Capacitor CLY5 is coupled between the drain of transistor QCL3 and the source of transistor QCL5. Capacitor CLY2 is coupled between the sources of transistors QCH2 and QCL2. Capacitor CFLY4 is coupled between the drain of transistor QCL2 and the source of transistor QCL4. Capacitor CFLY6 is coupled between the drain of transistor QCL4 and the source of transistor QCL6.

The drain of transistor QDL1 is coupled to capacitor CLFY1 and to the source of transistor QCL1. The source of transistor QDL1 is coupled to ground. The drain and source of transistor QDH1 are coupled to the source of transistor QCH1 and the output voltage terminal 102, respectively. The drain of transistor QDL2 is coupled to capacitor CLFY2 and to the source of transistor QCL2. The source of transistor QDL2 is coupled to ground. The drain and source of transistor QDH2 are coupled to the source of transistor QCH2 and the output voltage terminal 102, respectively.

The drain of transistor QDL3 is coupled to capacitor CLFY3 and to the source of transistor QCL3. The source of transistor QDL3 is coupled to ground. The drain and source of transistor QDH3 are coupled to the drain of transistor QCL1 and the output voltage terminal 102, respectively. The drain of transistor QDL4 is coupled to capacitor CLFY4 and to the source of transistor QCL4. The source of transistor QDL4 is coupled to ground. The drain and source of transistor QDH4 are coupled to the drain of transistor QCL2 and the output voltage terminal 102, respectively.

The drain of transistor QDL3 is coupled to capacitor CLFY3 and to the source of transistor QCL3. The source of transistor QDL3 is coupled to ground. The drain and source of transistor QDH3 are coupled to the drain of transistor QCL1 and the output voltage terminal 102, respectively. The drain of transistor QDL4 is coupled to capacitor CLFY4 and to the source of transistor QCL4. The source of transistor QDL4 is coupled to ground. The drain and source of transistor QDH4 are coupled to the drain of transistor QCL2 and the output voltage terminal 102, respectively. The drains of transistors QCL5 and QCL6 are coupled together. Capacitor COUT is coupled between the output voltage terminal 102 and ground.

Output 410a of control signal generator 410 is coupled to, and provides control signal PHASE2_CHG to, the gates of transistors QCH1, QCL1, QCL3, and QCL5. Output 410b of control signal generator 410 is coupled to, and provides control signal PHASE1_CHG to, the gates of transistors QCH2, QCL2, QCL4, and QCL6. Output 410c of control signal generator 410 is coupled to, and provides control signal PHASE2_DSCHG to, the gates of transistors QDH1, QDL1, QDH3, QDL3, QDH5, and QDL5. Output 410d of control signal generator 410 is coupled to, and provides control signal PHASE1_DSCHG to, the gates of transistors QDH2, QDL2, QDH4, QDL4, QDH6, and QDL6.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

What is claimed is:

1. A power converter, comprising:
a first transistor having first and second terminals and a control input;
a second transistor having first and second terminals and a control input;
a third transistor having a first terminal coupled to the second terminal of the first transistor and having a second terminal and a control input;
a fourth transistor having a first terminal coupled to the second terminal of the second transistor and having a second terminal and a control input;
a fifth transistor having a first terminal coupled to the second terminal of the third transistor and having a second terminal and a control input;
a sixth transistor having a first terminal coupled to the second terminal of the fourth transistor and having a second terminal and a control input;
a seventh transistor having a first terminal coupled to the second terminal of the fifth transistor and having a second terminal and a control input;
an eighth transistor having a first terminal coupled to the second terminal of the sixth transistor and having a second terminal and a control input;
a first capacitor having a first terminal coupled to the second terminal of the first transistor and having a second terminal coupled to the second terminal of the fifth transistor;
a second capacitor having a first terminal coupled to the second terminal of the second transistor and having a second terminal coupled to the second terminal of the sixth transistor; and
a control signal generator having first, second, third, and fourth outputs, the first output coupled to the control inputs of the first and fifth transistors, the second output coupled to the control inputs of the second and sixth transistors, the third output coupled to control inputs of the third and seventh transistors, and the fourth output coupled to control inputs of the fourth and eighth transistors.

2. The power converter of claim 1, wherein the control signal generator is configured to sequence on and off states of the first through eighth transistors through first, second, third, fourth, fifth, and sixth control phases for which:
in the first control phase, the first, fourth, fifth, and eighth transistors are on and the second, third, sixth, and seventh transistors are off;
in the second control phase, the first, second, fifth, and sixth transistors are on and the third, fourth, seventh, and eighth transistors are off;
in the third control phase, the second and sixth transistors are on and the first, third, fourth, fifth, seventh, and eighth transistors are off;
in the fourth control phase, the second, third, sixth, and seventh transistors are on and the first, fourth, and fifth transistors are off;
in the fifth control phase, the first, second, fifth, and sixth transistors are on and the third, fourth, seventh, and eighth transistors are off; and
in the sixth control phase, the first and fifth transistors are on and the second, third, fourth, sixth, seventh, and eighth transistors are off.

3. The power converter of claim 1, wherein the control signal generator is configured to sequence on and off states of the first through eighth transistors through first, second, third, fourth, fifth, and sixth control phases for which:
in the first control phase, the first capacitor at least partially charges and the second capacitor at least partially discharges;
in the second control phase, the first and second capacitors at least partially charge;
in the third control phase, the second capacitor at least partially charges;
in the fourth control phase, the first capacitor at least partially discharges and the second capacitor at least partially charges;
in the fifth control phase, the first and second capacitors at least partially charge; and
in the sixth control phase, the first capacitor at least partially charges.

4. The power converter of claim 1, further comprising:
a ninth transistor having a first terminal and a control input, the control input of the ninth transistor coupled to the first output of the control signal generator;
a third capacitor coupled between the first terminal of the fifth transistor and the first terminal of the ninth transistor;
a tenth transistor having a first terminal and a control input, the control input of the tenth transistor coupled to the second output of the control signal generator; and
a fourth capacitor coupled between the first terminal of the sixth transistor and the first terminal of the tenth transistor.

5. A power converter, comprising:
a first transistor having first and second terminals and a control input;
a second transistor having first and second terminals and a control input;
a third transistor having a first terminal coupled to the second terminal of the first transistor and having a second terminal and a control input;
a fourth transistor having a first terminal coupled to the second terminal of the second transistor and having a second terminal and a control input;
a fifth transistor having a first terminal coupled to the second terminal of the third transistor and having a second terminal and a control input;
a sixth transistor having a first terminal coupled to the second terminal of the fourth transistor and having a second terminal and a control input;
a seventh transistor having a first terminal coupled to the second terminal of the fifth transistor and having a second terminal and a control input;
an eighth transistor having a first terminal coupled to the second terminal of the sixth transistor and having a second terminal and a control input;
a first capacitor having a first terminal coupled to the second terminal of the first transistor and having a second terminal coupled to the second terminal of the fifth transistor;
a second capacitor having a first terminal coupled to the second terminal of the second transistor and having a second terminal coupled to the second terminal of the sixth transistor; and
a control signal generator coupled to the control inputs of the first through eighth transistors, the control signal generator configured to sequence on and off states of the first through eighth transistors through first, second, third, fourth, fifth, and sixth control phases for which:
in the first control phase, the first capacitor at least partially charges and the second capacitor at least partially discharges;
in the second control phase, the first and second capacitors at least partially charge;
in the third control phase, the second capacitor at least partially charges;
in the fourth control phase, the first capacitor at least partially discharges and the second capacitor at least partially charges;
in the fifth control phase, the first and second capacitors at least partially charge; and
in the sixth control phase, the first capacitor at least partially charges.

6. The power converter of claim 5, wherein the control signal generator has first, second, third, and fourth outputs, the first output coupled to the control inputs of the first and fifth transistors, the second output coupled to the control inputs of the second and sixth transistors, the third output coupled to control inputs of the third and seventh transistors, and the fourth output coupled to control inputs of the fourth and eighth transistors.

7. The power converter of claim 6, wherein the control signal generator is configured to sequence on and off states of the first through eighth transistors such that:
in the first control phase, the first, fourth, fifth, and eighth transistors are on and the second, third, sixth, and seventh transistors are off;
in the second control phase, the first, second, fifth, and sixth transistors are on and the third, fourth, seventh, and eighth transistors are off;
in the third control phase, the second and sixth transistors are on and the first, third, fourth, fifth, seventh, and eighth transistors are off;
in the fourth control phase, the second, third, sixth, and seventh transistors are on and the first, fourth, and fifth transistors are off;
in the fifth control phase, the first, second, fifth, and sixth transistors are on and the third, fourth, seventh, and eighth transistors are off; and
in the sixth control phase, the first and fifth transistors are on and the second, third, fourth, sixth, seventh, and eighth transistors are off.

8. A power converter, comprising:
a switch circuit having an input voltage terminal, an output voltage terminal, and a plurality of control inputs, the switch circuit comprising a plurality of transistors and;
a first capacitor having first and second terminals coupled to the switch circuit;
a second capacitor having a first and second terminals coupled to the switch circuit; and
a control signal generator coupled to the plurality of control inputs, the control signal generator configured to sequence the plurality of transistors through first, second, third, fourth, fifth, and sixth control phases for which:
in the first control phase, the first capacitor at least partially charges and the second capacitor at least partially discharges;
in the second control phase, the first and second capacitors at least partially charge;
in the third control phase, the second capacitor at least partially charges;
in the fourth control phase, the first capacitor at least partially discharges and the second capacitor at least partially charges;
in the fifth control phase, the first and second capacitors at least partially charge; and
in the sixth control phase, the first capacitor at least partially charges.

9. The power converter of claim 8, wherein the control signal generator has first, second, third, and fourth outputs, and each of the first through fourth outputs is coupled to at least two of the control inputs of the switch circuit.

10. The power converter of claim 8, wherein the switch circuit comprises:
a first transistor having first and second terminals and a control input;
a second transistor having first and second terminals and a control input;
a third transistor having a first terminal coupled to the second terminal of the first transistor and having a second terminal and a control input;
a fourth transistor having a first terminal coupled to the second terminal of the second transistor and having a second terminal and a control input;
a fifth transistor having a first terminal coupled to the second terminal of the third transistor and having a second terminal and a control input;
a sixth transistor having a first terminal coupled to the second terminal of the fourth transistor and having a second terminal and a control input;
a seventh transistor having a first terminal coupled to the second terminal of the fifth transistor and having a second terminal and a control input; and
an eighth transistor having a first terminal coupled to the second terminal of the sixth transistor and having a second terminal and a control input;
wherein each of the control inputs of the first through eighth transistors is coupled to a respective control input of the plurality of control inputs of the switch circuit.

11. The power converter of claim 10, wherein the control signal generator has first, second, third, and fourth outputs, the first output coupled to the control inputs of the first and fifth transistors, the second output coupled to the control inputs of the second and sixth transistors, the third output coupled to control inputs of the third and seventh transistors, and the fourth output coupled to control inputs of the fourth and eighth transistors.

12. The power converter of claim 10, wherein the control signal generator is configured to sequence on and off states of the first through eighth transistors such that:
in the first control phase, the first, fourth, fifth, and eighth transistors are on and the second, third, sixth, and seventh transistors are off;
in the second control phase, the first, second, fifth, and sixth transistors are on and the third, fourth, seventh, and eighth transistors are off;
in the third control phase, the second and sixth transistors are on and the first, third, fourth, fifth, seventh, and eighth transistors are off;
in the fourth control phase, the second, third, sixth, and seventh transistors are on and the first, fourth, and fifth transistors are off;
in the fifth control phase, the first, second, fifth, and sixth transistors are on and the third, fourth, seventh, and eighth transistors are off; and
in the sixth control phase, the first and fifth transistors are on and the second, third, fourth, sixth, seventh, and eighth transistors are off.
